(19) United States
(12) Patent Application Publication
(10) Pub. No.: US 2006/0256978 A1
(43) Pub. Date: Nov. 16, 2006

(54) Sparse signal mixing model and application to noisy blind source separation

(76) Inventors: Radu Victor Balan, West Windsor, NJ (US); Justinian Rosca, West Windsor, NJ (US); Christian Klaus Borss, Bochum (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/126,579

(22) Filed: May 11, 2005

(51) Int. Cl. H04B 15/00

(52) U.S. Cl. 381/94.7

(57) ABSTRACT

A computer-implemented method for blind-source separation includes capturing a mixed source signal by two or more sensors, transforming the mixed source signal from a time domain into a frequency domain, and estimating a mixing parameter of the mixed source signal. The method further includes determining a plurality of parameters of a source signal in the mixed source signal, separating the source signal from the mixed source signal under a sparsity constraint, transforming a separated source signal from the frequency domain into the time domain, and outputting the separated source signal.

### BACKGROUND OF THE INVENTION

1. Technical Field

The present invention relates to audio processing, and more particularly to a system and method for blind source separation.

2. Discussion of Related Art

Blind source separation is a general term used to describe techniques for identifying particular signals in a noisy environment. A classical example of blind source separation is the cocktail party problem. The cocktail party problem assumes that several people are speaking simultaneously in the same room; the problem is to separate the voices of the different speakers, using recordings or inputs from several microphones in the room.

Sparse signal representation techniques (e.g., blind source separation) transform signal data into a domain where data can be parsimoniously described, e.g., by a superposition of a small number of basis, or more generally, into a domain having a small l^{p}-norm (0≦p≦1). Known signal transformations include the Fourier, the wavelet, or independent component analysis (ICA) transformations. Taking sparseness as a prior assumption about signal models may be justified by the nature of signals (e.g., natural images, sounds). The assumption can lead to effective methods for signal separation. This has been the case in applications ranging from audio source separation to medical and image signal processing.

Jourjine et al. introduced a blind source separation technique for the separation of an arbitrary number of sources from just two mixtures using the assumption that time-frequency representations of any two sources do not overlap. Each time-frequency (TF) point depended on at most one source and its associated mixing parameters. This deterministic hypothesis was called W-disjoint orthogonality. In anechoic non-noisy environments, it is possible to extract the mixing parameters from the ratio of the TF representations of the mixtures. Using the mixing parameters, the TF representation of the mixtures can be partitioned to produce the original sources or separated signal.

The deterministic signal model was extended to a stochastic signal model in Balan and Rosca (“Statistical properties of STFT ratios for two channel systems and applications to blind source separation,” Proc. ICA-BSS, 2000), where each time-frequency coefficient was modeled as a product between a continuous random variable and a 0/1 discrete Bernoulli random variable (indicating the “presence” of the source). (STFT is an acronym for Short Time Fourier Transform.) This way signals can be modeled as independent random variables, and one can derive the maximum likelihood (ML) estimator of the mixing parameters. The sparse nature of the signal estimates implies that the time-domain reconstruction by time-frequency masking will contain artifacts. The problem is alleviated by Araki et al. by combination of masking and ICA.

Therefore, a need exists for a system and method for implementing a sparsity assumption in determining a separated signal.

### SUMMARY OF THE INVENTION

According to an embodiment of the present disclosure, a computer-implemented method for blind-source separation comprises capturing a mixed source signal by two or more sensors, transforming the mixed source signal from a time domain into a frequency domain, and estimating a mixing parameter of the mixed source signal. The method further comprises determining a plurality of parameters of a source signal in the mixed source signal, separating the source signal from the mixed source signal under a sparsity constraint, transforming a separated source signal from the frequency domain into the time domain, and outputting the separated source signal.

Determining the plurality of parameters comprises determining an indice of the mixed source signal in the frequency domain. The method further comprises determining a subset of the indice given a variable that defines a value of the source signal, wherein the source signal is an active signal.

The source signal is uniquely defined from among the mixed source signal by the plurality of parameters.

The method comprises determining a probability of measuring the source signal, given by an indice and variable that defines a value of the source signal, given the mixing model and the mixed source signal.

The separated source signal is a voice separated from a noise.

According to an embodiment of the present disclosure, a program storage device is provided, readable by machine, tangibly embodying a program of instructions executable by the machine to perform method steps for blind-source separation. The method steps comprise capturing a mixed source signal by two or more sensors, transforming the mixed source signal from a time domain into a frequency domain, and estimating a mixing parameter of the mixed source signal. The method further comprises determining a plurality of parameters of a source signal in the mixed source signal, separating the source signal from the mixed source signal under a sparsity constraint, transforming a separated source signal from the frequency domain into the time domain, and outputting the separated source signal.

According to an embodiment of the present disclosure, a computer-implemented method for blind-source separation comprises capturing a mixed source signal by two or more sensors, transforming the mixed source signal from a time domain into a frequency domain, and estimating a mixing parameter of the mixed source signal. The method further comprises determining a source signal in the mixed source signal given a mixing parameter by a maximum likelihood model, separating the source signal from the mixed source signal under a sparsity constraint, wherein the sparsity constraint comprises selecting a subspace of the mixed source signal, transforming a separated source signal from the frequency domain into the time domain, and outputting the separated source signal.

The mixed source signal is represented as a matrix and the subspace is a subset of columns or rows of the matrix.

The separated source signal is a desired signal separated from noise. The desired signal is a voice.

### BRIEF DESCRIPTION OF THE DRAWINGS

Preferred embodiments of the present disclosure will be described below in more detail, with reference to the accompanying drawings:

FIG. 1 is diagram of a system according to an embodiment of the present disclosure;

FIG. 2 is a graph illustrating a maximum likelihood method behavior according to an embodiment of the present disclosure;

FIG. 3 is a graph illustrating average SIR gains for maximum likelihood method and an ad-hoc estimator according to an embodiment of the present disclosure; and

FIG. 4 is a flow chart of a method according to an embodiment of the present disclosure.

### DETAILED DESCRIPTION OF PREFERRED EMBODIMENTS

For signal sources, such as human speech, the sources typically have a frequency of about 8 kHz-16 kHz. According to an embodiment of the present disclosure, the frequency of a source is greater than the frequency needed for performing signal separation. According to an embodiment of the present disclosure, a sparsity assumption is determined, which is applicable to blind source separation of noisy real-world audio signals. The sparsity assumption is given by a constraint on the maximum number of statistically independent sources present in a mixture of signals at any time and frequency point.

For a multi-channel (D>2) extension in the presence of noise, a sparsity assumption is implemented for blind source separation of noisy real-world audio signals. Maximum likelihood (ML) estimators are extended; an ML method according to an embodiment of the present disclosure considers both mixing parameters and sources.

Sparse constraints on signal decompositions are justified by the sensor data used in a variety of signal processing fields such as acoustics, medical imaging, or wireless. The sparseness assumption states that the maximum number of statistically independent sources active at any time and frequency point in a mixture of signals is small. This is shown to result from an assumption of sparseness of the sources themselves, and allows for a solution to a maximum likelihood formulation of a non-instantaneous acoustic mixing source estimation problem. An additive noise-mixing model may be implemented with an arbitrary number of sensors, including the case where there are more sources than sensors, when sources satisfy a sparseness assumption. A method according to an embodiment of the present disclosure is applicable to an arbitrary number of microphones and sources, and preferably to a case where the number of sources simultaneously active at any time frequency point is a small fraction of the total number of sources.

Experiments using eight sensors and four voice mixtures in the presence of noise show enhanced intelligibility of speech under the sparsity assumption.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

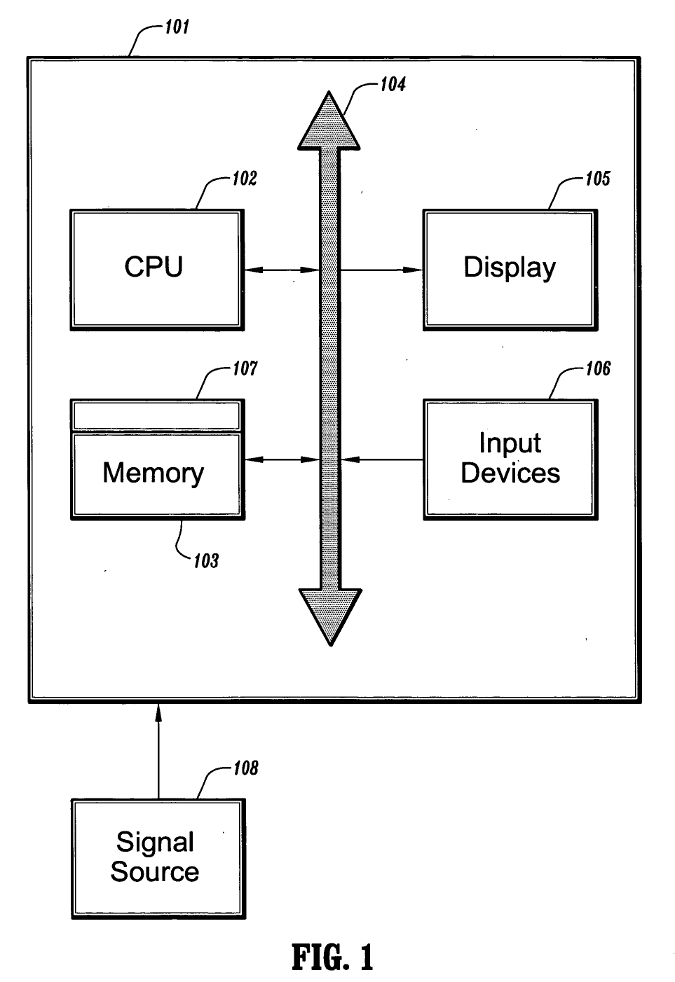

Referring to FIG. 1, according to an embodiment of the present invention, a computer system 101 for implementing the present invention can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Mixing Model Assumptions

Sparseness and the Generalized W-Disjoint Orthogonality Hypothesis; Two signals s₁ and s₂ may be called W-disjoint orthogonal for a given windowing function W(t) if the supports of the windowed Fourier transforms of s₁ and s₂ are disjoint, that is:
S₁(k,ω)S₂(k,ω)=0, ∀k,ω (1)

This deterministic assumption implies that the signals are in general statistically dependent, which is not the case. Yet, the relation given by Eq. (1) is satisfied in an approximate sense (e.g., in particular by real speech signals). Furthermore, Eq. (1) can be seen as the limit of a stochastic model introduced in R. Balan and J. Rosca, “Statistical properties of STFT ratios for two channel systems and applications to blind course separation,” in Proc. ICA-BSS, 2000.

According to an embodiment of the present disclosure, a stochastic model follows from a sparseness prior. L signals s₁,s₂, . . . , s_{L} are called generalized W-disjoint orthogonal (or N-term W-disjoint orthogonal) if, for every time-frequency point (t,ω), there are L-N indices {j_{N+1}, . . . , j_{N}} in {1,2, . . . , L} so that
Sⱼ_{ₖ}(t,ω)=0, ∀N+1≦k≦L. (2)

For Eqs. (2) and (5) k is a running index; elsewhere k is a time index.

The stochastic model and signal class states that the time-frequency coefficient S(k,ω) of a (speech) signal s(t) factors as a product of a continuous random variable, G(k,ω), and a 0/1 Bernoulli V(k,ω):
S(k,ω)=V(k,ω)G(k,ω) (3)

Eq. (3) models sparse signals. Denoting by q the probability of V to be 1, and by p(•) the probability density function of G, the probability density function of S may be given by:
pₛ(S)=qp(S)+(1−q)δ(S) (4)
with δ, the Dirac distribution. For L independent signals S₁, . . . , S_{L}, the joint probability density function is obtained by conditioning with respect to the Bernoulli random variables. To simplify the notation, it is assumed that all G(k,ω) have the same distribution p(•), and all V(k,ω) have the same q. Eq. (5) is obtained:

$$\begin{matrix}p ( {S}_{1} , … , {S}_{L} ) = {( qp ( S ) + ( 1 - q ) δ ( S ) )}^{L} \\ = {\sum }_{k = 0}^{L} {{q}^{k} ( 1 - q )}^{L - k} {\sum }_{1 \leq {a}_{1} \leq {a}_{2} \leq … \leq {a}_{k} \leq L}^{} {\prod }_{j = 1}^{k} p ( {S}_{{a}_{j}} ) \\ {\prod }_{j = k + 1}^{L} δ ( {S}_{{a}_{j}} )\end{matrix} \qquad ( 5 )$$

where {a₁,a₂, . . . , a_{L}}={1,2, . . . , L}.

Next assume q<<1 and approximate the expansion by only the first N terms. Renormalizing the remaining terms, the following equation is obtained

$$\begin{matrix}\begin{matrix}{p}_{GWDO} = \frac{{( 1 - q )}^{L}}{Z} {\prod }_{l = 1}^{L} δ ( {S}_{l} ) + q \frac{{( 1 - q )}^{L - 1}}{Z} {\sum }_{l = 1}^{L} p ( {S}_{l} ) {\prod }_{j \neq l}^{} δ ( {S}_{j} ) + \\ … {q}^{N} \frac{{( 1 - q )}^{L - N}}{Z} {\sum }_{1 \leq {a}_{1} \leq {a}_{2} \leq … \leq {a}_{N} \leq L}^{} {\prod }_{j = 1}^{N} p ( {S}_{{a}_{j}} ) {\prod }_{j = N + 1}^{L} δ ( {S}_{{a}_{j}} )\end{matrix} & ( 6 )\end{matrix}$$

with {a₁,a₂, . . . , a_{N},a_{N+1}, . . . , a_{L}}={1,2, . . . , L}, and

$$Z = {( 1 - q )}^{L - N} \frac{{( 1 - q )}^{N + 1} - {q}^{N + 1}}{1 - 2 q} .$$

The rank k term, 0≦k≦N, is associated to a case when exactly k sources are active, and the rest are zero. The joint probability density function in Eq. (6) corresponds to the case when at most N sources are active simultaneously, which constitutes the generalized W-disjoint hypothesis.

The generalized W-disjoint hypothesis is the stochastic counterpart of the deterministic constraint implied by Eq. (2). Eq. (6) shows that the constraint on the signals is a reasonable assumption in the stochastic limit, hence the name p_{GWDO}. It is assumed that the joint probability density function of the source signals in the short-time Fourier domain is given by Eq. (6), with the interpretation that this is not an inconsistent assumption but rather the limit of a stochastic model derived from assumptions of sparsity of the sources.

Mixing Model; a specific additive noise mixing model is implemented for non-instantaneous audio signals, where sensor noises are assumed independently distributed and have Gaussian distributions with zero mean and σ² variance.

Consider the measurements of L source signals by an equispaced linear array of D sensors under a far-field assumption where only the direct path is present. The far-field assumption states that the distance from the source is much larger than the dimensions of the sensor array. In this case, without loss of generality, the attenuation and delay parameters of the first mixture x₁(t) can be absorbed into the definition of the sources. The relative attenuation between sensors (e.g., the mixing model) may be given as:

$$\begin{matrix}{x}_{1} ( t ) = {\sum }_{l = 1}^{L} {s}_{1} ( t ) + {n}_{1} ( t ) \\ {x}_{d} ( t ) = {\sum }_{l = 1}^{L} {s}_{1} ( t - {τ}_{d , l} ) + {n}_{d} ( t ) , 2 \leq d \leq D\end{matrix} \qquad ( 7 )$$

where n₁, . . . , n_{D} are the sensor noises, and τ_{d,l} is the delay of source l to sensor d. For a far-field equispaced sensor array, the delays τ_{d,l} are linearly distributed across the sensors, with respect to index d. The average delay τ_{d,l} is defined so that
τ_{d,l}=(d−1)τₗ, 1≦d≦D,1≦l≦L (8)

Clearly other mixing models can be considered at the expense of increasing the model complexity. Δ denotes the maximal possible delay between adjacent sensors, and thus |η|≦Δ,∀l.

X_{d}(k,ω),Sₗ(k,ω),N_{d}(k,ω) denotes the short-time Fourier transform of signals x_{d}(t), sₗ(t), and n_{d}(t), respectively, with respect to a window W(t), where k is the frame index, and ω the frequency index. The short-time Fourier transform transforms the spectrum of the source signals, e.g., X, into the frequency domain. Then the mixing model Eq. (7) turns into:

$${X}_{d} ( k , ω ) = {\sum }_{l = 1}^{L} {ⅇ}^{- ⅈω ( d - 1 ) {τ}_{1}} {S}_{l} ( k , ω ) + {N}_{d} ( k , ω ) \qquad ( 9 )$$

When no danger of confusion arises, the arguments k,ω may be dropped in X_{d}, Sₗ and N_{d}.

Given measurements (x₁(t), . . . , x_{D}(t))_{1≦t≦T} of the system Eq. (7) the mixing parameters (τₗ)_{1≦l≦L} and the source signals (s₁(t), . . . , s_{L}(t))_{1≦t≦T} may be estimated.

The mixing parameters are estimated using a W-disjoint orthogonality assumption and the ML estimator. For example, for a given partition (Ωₗ)_{1≦l≦L}, where the time-frequency plane is portioned into L disjoint subsets Ω₁, . . . , Ω_{L}, where each source signal is non-zero, the mixing parameters may be obtained independently for each l by:

$${\hat{τ}}_{l} = arg {max}_{{τ}_{l}} {\sum }_{( k , ω ) ∈ {Ω}_{l}}^{} \frac{1}{{‖ {R}_{l} ( ω ) ‖}^{2}} {\vert 〈 {R}_{l} ( ω ) , X ( k , ω ) 〉 \vert}^{2} .$$

The source signals are estimated under a generalized W-disjoint orthogonality assumption.

Two Estimators of Signals

Accordingly to an embodiment of the present disclosure, the maximum likelihood estimator of source signals is derived, as well as an “ad-hoc” estimator of signals, both under the assumption of Eq. (2). At every TF point (k,ω) there is a subset of N indices, Π={j₁, . . . , j_{N}}⊂{1,2, . . . , L}, that specifies which signals are allowed to be nonzero. There are exactly N complex unknown variables, R=(R₁, . . . , R_{N}), that define the values of the active signals:
Sⱼ_{ₘ}(k,ω)=Rₘ(k,ω),1≦m≦N (10)
Sⱼ(k,ω)=0, j∉Π (11)
Eqs. (10) and (11) represent a sparsity assumption according to an embodiment of the present disclosure.

Hence the unknown source signals are uniquely defined by (Π,R).

The ML Estimator of (Π,R); Given the mixing parameters τₗ)_{1≦l≦L}, the likelihood of the source signal (Π,R) is then

$$ℒ ( Π , R ) = {\prod }_{( k , ω )}^{} {\prod }_{d = 0}^{D - 1} \frac{1}{{πσ}^{2}} exp \{ - \frac{1}{{σ}^{2}} {\vert {X}_{d + 1} ( k , ω ) - {Y}_{d} ( k , ω ) \vert}^{2} \} \\ where \\ {Y}_{d} ( k , ω ) = {\sum }_{l = 1}^{N} {ⅇ}^{- ⅈ d {τ}_{{{j}_{l} ( k , ω )}^{ω}}} {R}_{l} ( k , ω ) \qquad ( 12 )$$

Taking the logarithm and rearranging the expression, (Π,R) becomes the minimizer of:

$${min}_{Π , R} I ( Π , R ) = {\sum }_{ ( k , ω )}^{} {\sum }_{d = 0}^{D - 1} {\vert {X}_{d + 1} ( k , ω ) - {Y}_{d} ( k , ω ) \vert}^{2} \qquad ( 13 )$$

Then R is easily obtained at every TF point (k,ω) as a least square solution, namely
\hat{R}=(M*M)⁻¹M*X (14)
where M is the D×N matrix M_{d,l}=e^{-idτ}^{ⱼₗ}^{ω},0≦d≦D−1,1≦l≦N. Using Vandermonde determinates, it can be shown that the matrix M*M is invertible if and only if N≦D and ωτₗ≠ωτ_{f}(mod2π, for all l≠f. Assuming that this is the case, for example, by choosing N<D and (τₗ)ₗ to be distinct from one another and smaller than 1. Note the optimal solution depends on Π through the choice of indices (jₗ)ₗ. \hat{R} is replaced into Eq. (13) and the minimization of I turns into the maximization of:
max_{\hat{Π}}J(Π)=X*M(M*M)⁻¹M*X (15)
over all L-choose-N objects. The geometric interpretation of J(Π) is the following: it represents the size of the projection of X onto the span of columns of M,J(Π)=∥P_{M}X∥². Hence the optimal choice \hat{Π} represents the closest N-dimensional subspace of C^{D} to X among all

$$( \begin{matrix}L \\ N\end{matrix} )$$

subspaces spanned by different combinations of N columns of the matrix M.

Solving max J(Π) is in general a computationally expensive problem, since it includes generating all

$$( \begin{matrix}L \\ N\end{matrix} )$$

combinations of columns of M and determining J(Π) for each of them. For N=D−1 and L=D a solution may be obtained using the following observation; If jε{1, . . . , L} denotes the missing index in Π, then J(Π)=∥X∥²−|aⱼX|²/∥aⱼ∥² where aⱼ is the j^{th} row of the D×D matrix Q,Q_{d,j}=e^{-idτ}^{ⱼ}^{ω},1≦d,j≦D.

The method can be modified to deal with an echoic mixing model, or different array configurations at the expense of increased computational complexity. It includes knowledge of the number of sources, however this number is not limited to the number of sensors. It works also in non-square case. The method converges to a local minimum only.

Since Eq. (6) is used as the stochastic limit of Eq. (5), the derived signal estimator is the maximum a posteriori with respect to the prior joint probability density function Eq. (6). If the deterministic point of view is adopted regarding Eq. (2), the estimator is the maximum likelihood estimator.

An ad-hoc estimator of the source signal (Π,R); a second estimator of source signals has been derived for comparison. The second estimator is obtained by noticing that the estimates of the source signals have to satisfy the N-term W-disjoint orthogonality hypothesis and they have to fit as well as possible in Eq. (7). With these constraints in mind, the second estimator has been implemented; For each subset n={j₁, . . . , j_{N}} of {1,2, . . . , L} and every subset Γ={g₁, . . . , g_{N}}⊂{1,2, . . . , D} both of N elements, a solution is determined for the linear system:

$${X}_{{g}_{1}} ( k , ω ) = {\sum }_{f = 1}^{N} {ⅇ}^{- ⅈ ( {g}_{1} - 1 ) {τ}_{{i}_{j}} ω} {R}_{{j}_{i}}^{Γ , Π} ( k , ω ) , 1 \leq l \leq N \qquad ( 16 )$$

Then average the estimates for some source index j over all subsets Γ,

$${\tilde{R}}_{j}^{Π} = \frac{1}{{\sum }_{Γ} w ( Γ )} {\sum }_{Γ} w ( Γ ) {R}_{j}^{Γ , Π} ( k , ω ) \qquad ( 17 )$$

where the weight ω is chosen as ω(Γ)=1/\sqrt{Σ_{g⊂Γ}g²} because the errors are assumed to be larger for microphones further away from microphone 1. The mean square error is determined using:

$$K ( Π ) = \frac{1}{{\sum }_{Γ} {w}^{2} ( Γ ) {\sum }_{j ∈ Γ} {\vert {\tilde{R}}_{j}^{Π} \vert}^{2}} {\sum }_{Γ} {w}^{2} ( Γ ) {\sum }_{j ∈ Γ} {\vert {\tilde{R}}_{j}^{Π} - {R}_{j}^{Γ , Π} \vert}^{2}$$

and the optimal subset Π of N active sources is estimated by minimizing:
\overline{Π}argmin_{Π}K(Π) (18)

The signal estimator is then defined by \tilde{S}ⱼ=\tilde{R}ⱼ^{\overline{Π}}.

Experimental Results

The two estimators may be implemented as described and applied them on realistic voice mixtures generated with a ray-tracing model. The performance of the approach is determined as N, the number of sources active simultaneously, increases.

Mixtures consisted of four source signals in different room environments and Gaussian noise. The room size was 4×5×3.2 meters (m). Setups corresponding to anechoic and echoic mixing were used with reverberation time 130 ms. The microphones formed a linear array with 2 cm spacing. Source signals were distributed in the room. Input signals were sampled at 16 KHz. For time-frequency representation a Hamming window of 512 samples and 50% overlap was used. Noise was added on each channel. The average (individual) signal-to-noise-ratio (SNR) was 10 dB, while the average input signal-to-interference-ratio (SIR) was about −4.7 dB.

To compare results, three criteria were used: output average signal to interference ratio gain (includes other voices and noise), signal distortion, and mean opinion intelligibility score. The first two are defined as follows:

$$\begin{matrix}SIRgain = \frac{1}{{N}_{f}} {\sum }_{k = 1}^{{N}_{f}} 10 {log}_{10} ( \frac{{‖ {S}_{o} ‖}^{2}}{{‖ \hat{S} - {S}_{o} ‖}^{2}} \frac{{‖ X - {S}_{i} ‖}^{2}}{{‖ {S}_{i} ‖}^{2}} ) & ( 19 ) \\ distortion = \frac{1}{{N}_{f}} {\sum }_{k = 1}^{{N}_{f}} 10 {log}_{10} \frac{{‖ {S}_{o} - {S}_{i} ‖}^{2}}{{‖ {S}_{i} ‖}^{2}} & ( 20 )\end{matrix}$$

where: N_{f} is the number of frames where the summand is above −10 dB for SIR gain, and −30 dB for distortion; Ŝ is the estimated signal that contains S₀ contribution of the original signal; X is the mixing at sensor 1, and Sᵢ is the input signal of interest at sensor 1. The summands were saturated at +30 dB for SIR gain and +10 dB for distortion. SIR gain should be a large positive, whereas distortion should be a large negative.

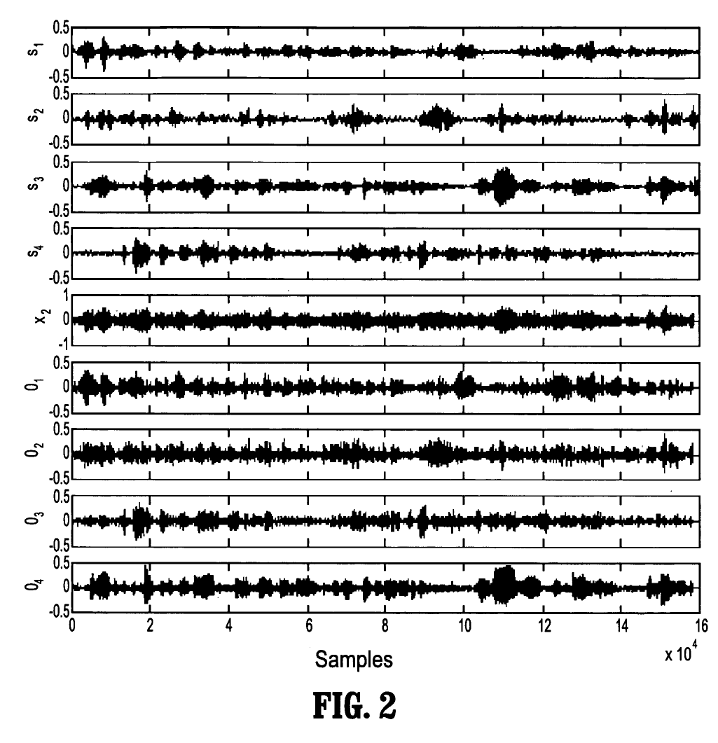

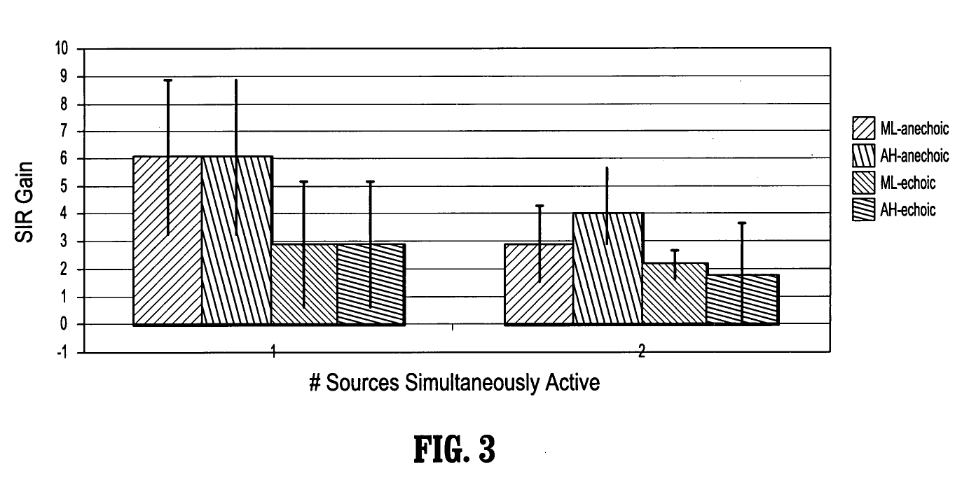

Tests were performed on noisy data for which SIR level for each source is approximately −4.7 dB, while noise determines an SNR level for the average voice on a channel of 10 dB. FIG. 2 shows plots of the wav files of interest for a run of the method where the mixing parameters were obtained using an ML method According to an embodiment of the present disclosure, it is assumed at most one source active at any time frequency point, while Π and source estimation parameters were determined using the implementation of the present estimators. Average SIR gains shows a degradation in performance from N=1 to N=2, and from anechoic to echoic data (See FIG. 3). However, mean intelligibility scores are best when the number of sources simultaneously active at any time frequency point is N=2. By increasing the number of active sources from N₁=1 to N₂=2, the total noise power in the outputs increases by a factor of N₂/N₁, or 3 dB, explaining some of the drop in SIR gain in FIG. 3. Desirable separation is achieved when N is a small fraction of the total number of sources.

FIG. 2 is an example of 8-channel ML method behavior on mixture of noise and four voices each at approximately −4.7 dB input SIR. The plots o₁-o₄ represent the original inputs. The row x₂ gives the mixture on channel 2. The separated outputs are presented in rows s₁-s₄.

FIG. 3 is a graph of the average SIR gains and one standard deviation bars for anechoic and echoic experiments with implementations of the ML and Ad-Hoc estimators.

A small number of simultaneously active sources in time-frequency domain is justifiable from a stochastic perspective. This hypothesis, called generalized W-disjoint orthogonality, is obtained as an asymptotic approximation in the expansion of the joint probability density function of sparse sources.

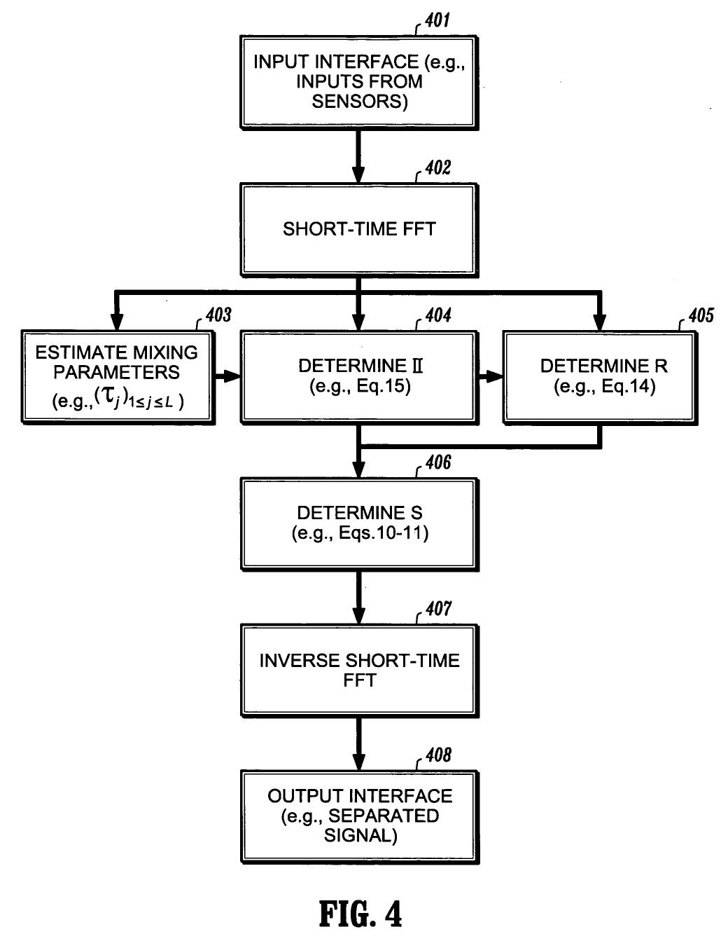

Referring to FIG. 4, a source separation method according to an embodiment of the present disclosure implements both the ML and a heuristic estimator for source signals under a direct-path mixing model and for a linear array of sensors in the presence of noise.

The source signals, e.g., from two or more microphones, are input 401. The source signals are transformed into a frequency domain 402. Given the source signals in the frequency domain, mixing parameters are estimated 403. The estimated mixing parameters are implemented to determine an index of the source signal 404. The index is optimized by a variable; a subset or combination of indices is determined given the variable 405. An unknown source signal is determined under a sparsity assumption given the index and variable 406. The determined source signal, which is in the frequency domain, is transformed into a spectral domain 407 and output 408. The determined source signal may be, depending on a desired application, a speaker's voice separated from background noise in an environment such as a car's interior. Other applications may include ease-dropping on remote signal sources, or sonar applications for tracking signal sources that may need to be separated from other signal sources.

Tests with a method according to an embodiment of the present disclosure on noisy mixtures show that the perceptual quality of separated signals improves at the expense of a smaller reduction in the noise by assuming that two signals are active simultaneously at every time-frequency point rather than one.

Having described embodiments for a system and method for a sparse signal mixing model and application, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer-implemented method for blind-source separation comprising:
capturing a mixed source signal by two or more sensors;
transforming the mixed source signal from a time domain into a frequency domain;
estimating a mixing parameter of the mixed source signal;
determining a plurality of parameters of a source signal in the mixed source signal;
separating the source signal from the mixed source signal under a sparsity constraint;
transforming a separated source signal from the frequency domain into the time domain; and
outputting the separated source signal.

2. The method of claim 1, wherein determining the plurality of parameters comprises determining an indice of the mixed source signal in the frequency domain.

3. The method of claim 2, further comprising determining a subset of the indice given a variable that defines a value of the source signal, wherein the source signal is an active signal.

4. The method of claim 1, wherein the source signal is uniquely defined from among the mixed source signal by the plurality of parameters.

5. The method of claim 1, further comprising determining a probability of measuring the source signal, given by an indice and variable that defines a value of the source signal, given the mixing model and the mixed source signal.

6. The method of claim 1, wherein the separated source signal is a voice separated from a noise.

7. A program storage device readable by machine, tangibly embodying a program of instructions executable by the machine to perform method steps for blind-source separation, the method steps comprising:
capturing a mixed source signal by two or more sensors;
transforming the mixed source signal from a time domain into a frequency domain;
estimating a mixing parameter of the mixed source signal;
determining a plurality of parameters of a source signal in the mixed source signal;
separating the source signal from the mixed source signal under a sparsity constraint;
transforming a separated source signal from the frequency domain into the time domain; and
outputting the separated source signal.

8. The method of claim 7, wherein determining the plurality of parameters comprises determining an indice of the mixed source signal in the frequency domain.

9. The method of claim 8, further comprising determining a subset of the indice given a variable that defines a value of the source signal, wherein the source signal is an active signal.

10. The method of claim 7, wherein the source signal is uniquely defined from among the mixed source signal by the plurality of parameters.

11. The method of claim 7, further comprising determining a probability of measuring the source signal, given by an indice and variable that defines a value of the source signal, given the mixing model and the mixed source signal.

12. The method of claim 7, wherein the separated source signal is a voice separated from a noise.

13. A computer-implemented method for blind-source separation comprising:
capturing a mixed source signal by two or more sensors;
transforming the mixed source signal from a time domain into a frequency domain;
estimating a mixing parameter of the mixed source signal;
determining a source signal in the mixed source signal given a mixing parameter by a maximum likelihood model;
separating the source signal from the mixed source signal under a sparsity constraint, wherein the sparsity constraint comprises selecting a subspace of the mixed source signal;
transforming a separated source signal from the frequency domain into the time domain; and
outputting the separated source signal.

14. The method of claim 13, wherein the mixed source signal is represented as a matrix and the subspace is a subset of columns or rows of the matrix.

15. The method of claim 13, wherein the separated source signal is a desired signal separated from noise.

16. The method of claim 15, wherein the desired signal is a voice.
